(19) United States
(12) Patent Application Publication
(10) Pub. No.: US 2020/0148017 A1
(43) Pub. Date: May 14, 2020

(54) TIRE PRESSURE SENSOR DEVICE

(71) Applicant: Yingwu Nie, Shenzhen (CN)

(72) Inventor: Yingwu Nie, Shenzhen (CN)

(21) Appl. No.: 16/361,263

(22) Filed: Mar. 22, 2019

(30) Foreign Application Priority Data
Nov. 9, 2018 (CN) 201821850820.X

(51) Int. Cl. B60C 23/04; B60C 29/06

(52) U.S. Cl. CPC B60C 23/0494; B60C 29/066; B60C 23/0493

(57) ABSTRACT

The present disclosure relates to a tire pressure sensor device, including a housing mounted with a sensor body, an air valve, and a connecting portion extending from the housing for mounting the air valve. The connecting portion is provided with a first groove in a shape of a spherical cap. A bottom surface of the first groove is provided with a strip-shaped through-hole penetrating through a bottom portion of the first groove. A plastic plug is detachably mounted on and mating with the first groove, and a top portion of the plastic plug is provided with a second groove. The plastic plug is further provided with a circular through-hole penetrating through a bottom surface of the second groove. The air valve is fixedly connected to the housing by screws passing through the strip-shaped through-hole, or the strip-shaped through-hole and the circular through-hole.

### CROSS REFERENCE TO RELATED APPLICATIONS

The present application claims the benefit of Chinese Patent Application No. 201821850820.X filed on Nov. 9, 2018, the contents of which are incorporated herein by reference in its entirety.

### TECHNICAL FIELD

The present disclosure relates to an automobile accessory, and in particular to a universal tire pressure sensor device which can use a metal air valve and a rubber air valve and can adjust angles.

### BACKGROUND TECHNOLOGY

An automobile tire pressure sensor is an accessory that is often installed on automobiles. When an original part is damaged or out of power, it is necessary to replace with a replacement part. There are two types of tire pressure sensors available in the market. One is applied for angle adjustable metal air valve and the other is applied for rubber air valve. These two are not universal. The problem that arises is that the sensor can only be installed with a metal air valve, but cannot be replaced by a rubber air valve; or the sensor can only be installed with a rubber air valve, but cannot be replaced by a metal air valve. Hence, maintenance becomes difficult because corresponding matching components must be used. In order to maintain the consistency with the original air valve (metal or rubber), a maintenance personnel must prepare an inventory of both metal and rubber sensors. This increases pressure on inventory and capital cost for the agent.

### SUMMARY

In view of the existing deficiencies, the present disclosure provides a universal tire pressure sensor device which can use both a metal valve and a rubber valve and can adjust angles.

The technical solution adopted by the present disclosure to solve the technical problem is as follows:

A tire pressure sensor device may include a housing mounted with a sensor body, an air valve, and a connecting portion extending from the housing for mounting the air valve. The connecting portion may be provided with a first groove in a shape of a spherical cap, and a bottom surface of the first groove may be provided with a strip-shaped through-hole penetrating through a bottom portion of the first groove. A plastic plug may be detachably mounted on and mating with the first groove. A top portion of the plastic plug may be provided with a second groove. The plastic plug may be further provided with a circular through-hole penetrating through a bottom surface of the second groove. The air valve may be fixedly connected to the housing by screws passing through the strip-shaped through-hole, or the strip-shaped through-hole and the circular through-hole.

Preferably, a bottom portion of the plastic plug may extend around the circular through-hole to form an extending portion that is fittingly embedded into the strip-shaped through-hole, and the circular through-hole may extend through the extending portion.

Preferably, the second groove may be an oval-shaped groove.

Preferably, the first groove may be provided with a flat surface on an inner wall corresponding to a long side direction of the strip-shaped through-hole, and a surface of the plastic plug that corresponds to the flat surface may also be planar in shape.

Preferably, the connecting portion may be a column body having a semi-circular ring-shaped cross section.

Preferably, the plastic plug may be in the shape of a spherical cap, and a height of the spherical cap may be greater than a radius of the spherical cap.

Preferably, the plastic plug may be an elastic deformable plastic plug, or the plastic plug may be made of hard plastic.

The beneficial effects of the present disclosure are as follows:

In the present disclosure, the first groove has the shape of a spherical cap and can facilitate angle adjustment and installation of a metal air valve, and the strip-shaped through-hole can facilitate fixing of a screw. The plastic plug is configured to allow a rubber air valve to be mounted on the housing, which can be fitted with either a metal air valve or a rubber air valve. The angle of installation can also be adjusted. This can solve the problem that the conventional tire pressure sensor is not universal for angle adjustable metal and rubber air valves.

### BRIEF DESCRIPTION OF THE DRAWINGS

FIG. 1 is a schematic view showing the structure of a plastic plug of spherical cap shape being separated from a housing according to a first embodiment of the present disclosure;

FIG. 2 is a bottom view of the structure of a plastic plug with an extending portion according to a second embodiment of the present disclosure; and

FIG. 3 is a schematic view of the structure of the housing combined with an air valve according to an embodiment of the present disclosure.

Names and reference numerals of the components shown in the FIGS.: 1—housing, 2—air valve, 3—connecting portion, 30—first groove, 31—strip-shaped through-hole, 300—flat surface, 4—plastic plug, 40—second groove, 41—extending portion, 42—circular through-hole, 5—screw.

### DETAILED DESCRIPTION OF THE EMBODIMENTS

The present disclosure will be further described with reference to the accompanying drawings and embodiments. Some embodiments of the present disclosure, rather than all of the embodiments, are described. All other embodiments obtained by a person of ordinary skill in the art based on the embodiments of the present disclosure without any creative work are within the scope of the present disclosure. In addition, the directional terms mentioned in the present disclosure, for example, “upper”, “lower”, “front”, “back”, “left”, “right”, “inside”, “outside”, etc. are only directional terms used in the drawings, are intended to provide a better and clearer description of the present disclosure and are not intended to limit the scope of the disclosure.

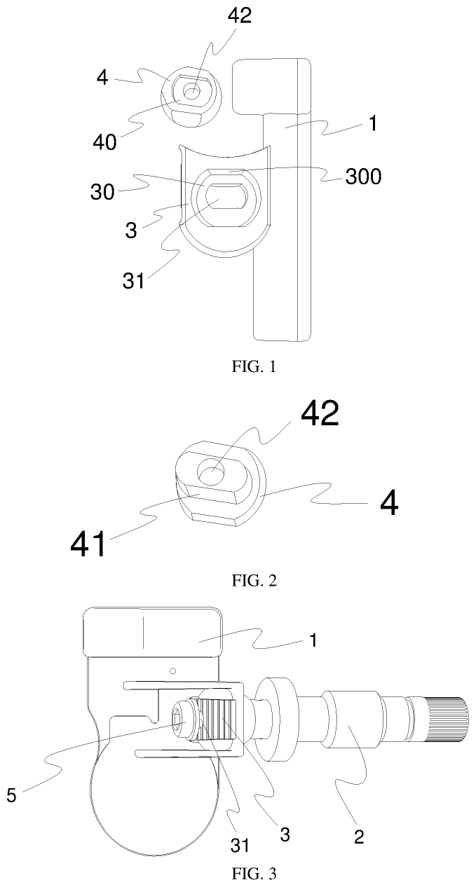

As shown in the embodiments of the present disclosure in FIG. 1 to FIG. 3, for example, a tire pressure sensor device may include a housing 1 mounted with a sensor body, an air valve 2, and a connecting portion 3 extending from the housing 1 for mounting the air valve 2. The connecting portion 3 may be provided with a first groove 30 in the shape of a spherical cap. A bottom surface of the first groove 30 may be provided with a strip-shaped through-hole 31 penetrating through a bottom portion of the first groove 30. A plastic plug 4 may be detachably mounted on and mating with the first groove 30. A top portion of the plastic plug 4 may be provided with a second groove 40. The plastic plug 4 may be further provided with a circular through-hole 42 penetrating through a bottom surface of the second groove 40. The air valve 2 can be fixedly connected to the housing 1 by screws passing through the strip-shaped through-hole 31, or the strip-shaped through-hole 31 and the circular through-hole 42. To use a metal air valve, the plastic plug 4 is removed, and the ball head of the metal air valve is inserted in the first groove 3. The screw 5 is passed through the strip-shaped through-hole 30 from the bottom portion of the connecting portion 3 and connected with the air valve 2. After adjusting the angle, the screw 5 is tightened so that the air valve 2 can be fixed in the first groove 30. When a rubber air valve 2 is required to be used, the metal air valve is unscrewed. The plastic plug 4 can be first installed in the first groove 30, and then the rubber air valve is inserted into the second groove 40. The screw 5 is passed through the strip-shaped through-hole 31 and the circular through-hole 42 from the bottom portion of the connecting portion 3, and connected to the air valve 2. Such a structure can be used to install either a metal air valve or a rubber air valve. This can solve the problem that the conventional tire pressure sensor is not universal for angle adjustable metal and rubber air valves. This can also expand the range of usage of the sensor. At the same time of installing air valves of different materials, the angle can also be adjusted. Therefore, it is very convenient to use. In order to better fit the rubber air valve to the second groove 40, the second groove 40 may be in the form of an oval-shaped groove. In order to fix the position of the air valve 2 after installation, a bottom portion of the plastic plug 4 around the circular through-hole 42 may be extended to form an extending portion 41. The extending portion 41 can be fittingly embedded into the strip-shaped through-hole 31, and the circular through-hole 42 may extend through the extending portion 41. The air valve 2 can be fixedly coupled to the housing 1 by the screw 5 passing through the strip-shaped through-hole 31 and the circular through-hole 42.

In a further improvement, as shown in FIG. 1, since the ball head of the metal air valve is usually flattened to form a flat surface, the first groove 30 may be provided with a flat surface 300 on an inner wall that corresponds to a long side direction of the strip-shaped through-hole 31. Thus, when the metal air valve is installed, the flat surface 300 on the inner wall of the first groove 30 can be abutted against the flat surface of the ball head of the metal air valve, so that the metal air valve can be more firmly installed and cannot be easily loosened. In order to fit the plastic plug 4 in the first groove 30, a surface of the plastic plug 4 that corresponds to the flat surface 300 may also be planar in shape. The mounting through the matching of two flat surfaces can be more secure.

In a further improvement, as shown in FIG. 1, the connecting portion 3 may be a column body having a semi-circular ring-shaped cross section. This can facilitate the setting of the first groove 30. The semi-circular ring-shaped connecting portion can well surround the air valve 2. This can avoid the problem that, in caser it is smaller than a semi-circle, the air valve may slide out from the column body 3 during angle adjustment or in use. This can also avoid the problem that, in case it is larger than a semi-circle, it is not easy to assemble. The diameter of the connecting portion 3 may be preferably adapted to the diameter of the ball head of the air valve.

In a further improvement, as shown in FIG. 1, the plastic plug 4 may be in the shape of a spherical cap, and the height of the spherical cap may be greater than the radius of the spherical cap. In this way, there will not be a problem that the plastic plug 4 can fall out from the first groove 30 during angle adjustment of the rubber air valve. At the same time, the plastic plug 4 can be an elastic deformable plastic plug, or it can be made of hard plastic. When subjected to an external force, the plastic plug can elastically deform and dampen the impact of the external force. Hence, this can increase its service life. The hard plastic can better mate with the first groove 30. The plastic plug can be a common rubber plug. Rubber plugs are easy to manufacture and low in price. Hence, it can increase production efficiency and reduce production cost.

It is to be understood that those skilled in the art will be able to make modifications and changes in accordance with the above description, and all such modifications and changes are to be included within the scope of protection of the appended claims.

What is claimed is:

1. A tire pressure sensor device, comprising a housing mounted with a sensor body, an air valve, a connecting portion extending from the housing for mounting the air valve, the connecting portion being provided with a first groove in a shape of a spherical cap, a bottom surface of the first groove being provided with a strip-shaped through-hole penetrating through a bottom portion of the first groove, and a plastic plug being detachably mounted on and mating with the first groove, a top portion of the plastic plug being provided with a second groove, the plastic plug further provided with a circular through-hole penetrating through a bottom surface of the second groove, and the air valve being fixedly connected to the housing by screws passing through the strip-shaped through-hole, or the strip-shaped through-hole and the circular through-hole.

2. The tire pressure sensor device according to claim 1, wherein a bottom portion of the plastic plug around the circular through-hole is extended to form an extending portion that fittingly embedded into the strip-shaped through-hole, and the circular through-hole extends through the extending portion.

3. The tire pressure sensor device according to claim 1, wherein the second groove is an oval-shaped groove.

4. A tire pressure sensor device according to claim 1, wherein the first groove is provided with a flat surface on an inner wall that corresponds to a long side direction of the strip-shaped through-hole, and a surface of the plastic plug that corresponds to the flat surface is also planar in shape.

5. The tire pressure sensor device according to claim 1, wherein the connecting portion is a column body having a semi-circular ring-shaped cross section.

6. The tire pressure sensor device according to claim 1, wherein the plastic plug is in the shape of a spherical cap, and a height of the spherical cap is greater than a radius of the spherical cap.

7. The tire pressure sensor device according to claim 1, wherein the plastic plug is an elastic deformable plastic plug, or the plastic plug is made of hard plastic.

8. The tire pressure sensor device according to claim 2, wherein the plastic plug is an elastic deformable plastic plug, or the plastic plug is made of hard plastic.

9. The tire pressure sensor device according to claim 3, wherein the plastic plug is an elastic deformable plastic plug, or the plastic plug is made of hard plastic.

10. The tire pressure sensor device according to claim 4, wherein the plastic plug is an elastic deformable plastic plug, or the plastic plug is made of hard plastic.

11. The tire pressure sensor device according to claim 5, wherein the plastic plug is an elastic deformable plastic plug, or the plastic plug is made of hard plastic.

12. The tire pressure sensor device according to claim 6, wherein the plastic plug is an elastic deformable plastic plug, or the plastic plug is made of hard plastic.
